(19) United States
(12) Patent Application Publication
(10) Pub. No.: US 2010/0208037 A1
(43) Pub. Date: Aug. 19, 2010

(54) IMAGE DISPLAYING SYSTEM AND IMAGE CAPTURING AND DISPLAYING SYSTEM

(75) Inventor: Tomonari Sendai, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/705,987

(22) Filed: Feb. 16, 2010

(30) Foreign Application Priority Data
Feb. 19, 2009 (JP) 2009-036999

(51) Int. Cl. H04N 13/04; G01J 1/42; H04N 13/02

(52) U.S. Cl. 348/46; 250/393; 348/51; 348/E13.074; 348/E13.075

(57) ABSTRACT

An image displaying system includes an image processor and a display unit. The image processor moves and/or deforms a first radiographic image and a second radiographic image that has been captured after the first radiographic image such that the first radiographic image and the second radiographic image are aligned. The display unit displays the first radiographic image and the second radiographic image that have been aligned, allows one of the first and second radiographic image to be viewed by the right eye, and allows the other of the first and second radiographic image to be viewed by the left eye.

### CROSS-REFERENCE TO RELATED APPLICATION

This application claims priority under 35 USC 119 from Japanese Patent Application No. 2009-036999 filed on Feb. 19, 2009, the disclosure of which is incorporated by reference herein.

### BACKGROUND OF THE INVENTION

1. Field of the Invention

The present invention relates to an image displaying system and an image capturing and displaying system.

2. Description of the Related Art

Japanese Patent Application Laid-Open (JP-A) No. 2007-229201 discloses a stereo mammography device. In this stereo mammography device, an X-ray source is moved in a direction parallel to a surface that the body of an examinee faces and plural mammographic images having different disparity angles in this direction are captured to obtain left and right stereo images. Moreover, by configuring a vertical stereo screen in which the images are vertically juxtaposed and using simple stereo glasses, a stereo view can be readily obtained.

National Publication (JP-A) No. 2003-531516 discloses an image processing system. In this image processing system, images before biopsy and after biopsy are processed to visually document and display the position inside the living body from which the biopsy specimen was collected. A composite image that visually accentuates the difference between the image before biopsy and the image after biopsy is created. A three-dimensional digitized image capable of being displayed in various projections can be stored in a computer-readable medium for the purpose of storage. An image processor uses an optical correlator to accurately register the images before biopsy and after biopsy. Next, these images are compared per voxel to detect the difference between the image before biopsy and the image after biopsy. The composite image is displayed using a comprehensive color, a comprehensive icon, or another visual hint to accentuate the possible living body biopsy position.

However, in the configuration of JP-A No. 2003-531516, one composite image (e.g., a three-dimensional digital image) in which the image before biopsy and the image after biopsy are combined is created. For this reason, image processing for combining the images becomes necessary and processing becomes cumbersome.

### SUMMARY OF THE INVENTION

In consideration of the above-described circumstances, the present invention provides an image displaying system and an image capturing and displaying system where reading/interpreting efficiency when comparing and reading/interpreting a radiographic image and a radiographic image that has been captured thereafter is improved.

A first aspect of the invention is an image displaying system including: an image processor that moves and/or deforms a first radiographic image and a second radiographic image that has been captured after the first radiographic image such that the first radiographic image and the second radiographic image are aligned; and a display unit that displays the first radiographic image and the second radiographic image that have been aligned, allows one of the first and second radiographic image to be viewed by the right eye, and allows the other of the first and second radiographic image to be viewed by the left eye.

In this configuration, if the first radiographic image and the second radiographic image are similar images, there will be no disparity, and the images will be perceived by the image radiologist and/or technologist as a planar image.

If there is an abnormal portion in either the first radiographic image or the second radiographic image, there will be disparity in that portion, and that portion will be perceived by the radiologist/technologist as a convex portion or a concave portion.

In this manner, when comparing and reading/interpreting the first radiographic image and the second radiographic image that has been captured thereafter, any abnormal portion can be discovered without having to perform image processing for combining images. For that reason, reading/interpreting efficiency when comparing and reading/interpreting a radiographic image and a radiographic image that has been captured thereafter can be improved without having to perform cumbersome processing.

A second aspect of the invention is an image capturing and displaying system including: the image displaying system according to the first aspect; and a radiographic image capturing device that includes: a movable radiation source that irradiates a subject with radiation in the same position as an imaging position of the first radiographic image when capturing the second radiographic image; and a radiation detector that detects the radiation with which the subject has been irradiated from the movable radiation source and which has passed through the subject, with a radiographic image being generated from that detected radiation.

In this manner, the radiation source irradiates the subjects with radiation in the same position, and the first radiographic image and the second radiographic image are generated. For that reason, there is little image distortion between the first radiographic image and the second radiographic image, and it becomes easier to align the first radiographic image and the second radiographic image.

A third aspect of the invention is an image capturing and displaying system including: the image displaying system according to the first acpect; and a radiographic image capturing device that includes: a movable radiation source that irradiates a subject with radiation; and a radiation detector that detects the radiation with which the subject has been irradiated from the movable radiation source and which has passed through the subject, with a radiographic image being generated from that detected radiation.

In the third aspect, the radiographic image capturing device may further have an object table on which the subject rests and a display device that displays the degree of alignment between a third radiographic image in which the subject resting on the object table has been captured and the first radiographic image.

Thus, a second radiographic image in which there is little distortion with the first radiographic image can be captured, and it becomes easier to align the first radiographic image and the second radiographic image.

In the third aspect, the radiographic image capturing device may further have an object table on which the subject rests, an optical image capturing device that captures, from the same direction as the radiation source, the subject resting on the object table, and a display device that displays a degree of alignment between an optical image that is obtained by the optical imaging device and the first radiographic image.

In this configuration, an operator can, on the basis of the position of the subject in the optical image, grasp how that position should be changed so that it matches the imaging position of the first radiographic image when capturing the second radiographic image.

Thus, a second radiographic image in which there is little distortion with the first radiographic image can be captured, and it becomes easier to align the first radiographic image and the second radiographic image.

In the third aspect, the radiographic image capturing device may further have a display device that displays the first radiographic image.

In this configuration, an operator can align the position of the subject such that it matches the first radiographic image while looking at the first radiographic image displayed on the display device.

Thus, a second radiographic image in which there is little distortion with the first radiographic image can be captured, and it becomes easier to align the first radiographic image and the second radiographic image.

In the above-described configuration, the display device may be a projection device that projects the first radiographic image onto an object table on which the subject rests.

In this configuration, an operator can align the position of the subject such that it coincides with the first radiographic image projected onto the imaging surface.

Thus, a second radiographic image in which there is little distortion with the first radiographic image can be captured, and it becomes easier to align the first radiographic image and the second radiographic image.

In the above-described configuration, the display device may be a projection device that projects the first radiographic image onto a compression plate that compresses the subject.

In this configuration, an operator can align the position of the subject such that it coincides with the first radiographic image projected onto the compression plate.

Thus, a second radiographic image in which there is little distortion with the first radiographic image can be captured, and it becomes easier to align the first radiographic image and the second radiographic image.

### BRIEF DESCRIPTION OF THE DRAWINGS

An exemplary embodiment of the present invention will be described in detail based on the following figures, wherein:

FIG. 1 is a general side view showing the configuration of a radiographic image capturing device pertaining to the exemplary embodiment;

FIG. 2 is a general front view showing the configuration of the radiographic image capturing device pertaining to the exemplary embodiment;

FIG. 3 is a general front view showing the configuration of the radiographic image capturing device during MLO imaging;

FIG. 4 is a general side view showing the configuration of the radiographic image capturing device equipped with a display device that displays the degree of alignment between a third radiographic image in which a subject resting on an object table has been captured and a first radiographic image;

FIG. 5 is a general side view showing the configuration of the radiographic image capturing device equipped with a display device that displays the degree of alignment between an optical image in which the subject resting on the image capturing table has been captured and the first radiographic image;

FIG. 6 is a general side view showing the configuration of the radiographic image capturing device equipped with a display device that displays the first radiographic image;

FIG. 7 is a general side view showing the configuration of the radiographic image capturing device equipped with a projection device that projects the first radiographic image onto an imaging surface;

FIG. 8 is a general side view showing the configuration of the radiographic image capturing device equipped with a projection device that projects the first radiographic image onto a compression plate;

FIG. 9 is a general diagram of an image displaying system pertaining to the exemplary embodiment;

FIG. 10 is a general perspective view of an image displaying device pertaining to the exemplary embodiment; and

FIG. 11 is a general side view of the image displaying device pertaining to the exemplary embodiment.

### DETAILED DESCRIPTION OF THE INVENTION

An exemplary embodiment will be described below on the basis of the drawings. An image capturing and displaying system pertaining to the present exemplary embodiment is equipped with a radiographic image capturing device 10 that captures radiographic images and an image displaying system 48 that displays images that have been captured by the radiographic image capturing device 10.

(Configuration of Radiographic Image Capturing Device 10)

The radiographic image capturing device 10 pertaining to the exemplary embodiment is a device that uses radiation (e.g., X-rays) to capture an image of breasts N serving as one example of a subject, and the radiographic image capturing device 10 is, for example, called a mammography device.

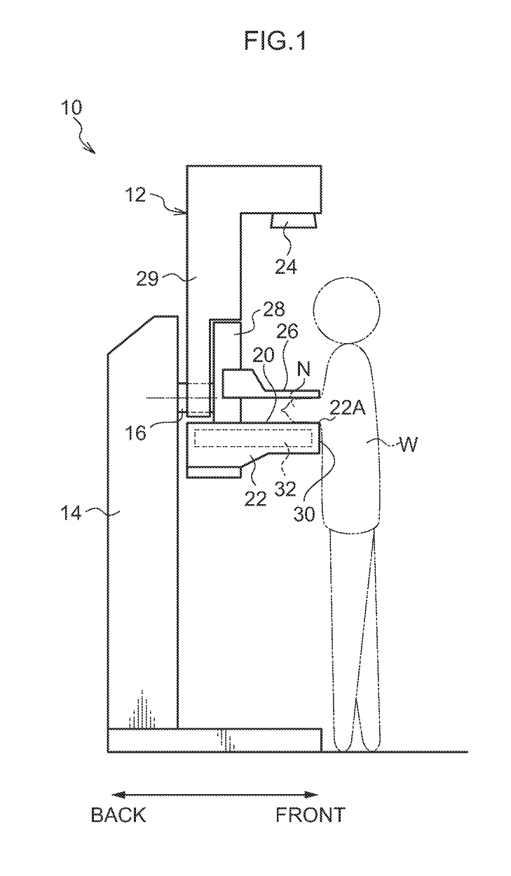

The radiographic image capturing device 10 is, as shown in FIG. 1, configured such that an image of the breasts N of that examinee W is captured in a standing state of an examinee (subject). Hereinafter, the side near the examinee W facing the radiographic image capturing device 10 will be described as the front of the radiographic image capturing device 10, and the far side away from the examinee W will be described as the back of the radiographic image capturing device 10 (see the arrows in FIG. 1). It will be noted that the front and back of the device are not limited to this.

The target of image capture of the radiographic image capturing device 10 is not limited to the breasts N and may also, for example, be another part of the body or an object. The radiographic image capturing device 10 may also be a device that captures an image of the breasts N of that examinee W in a sitting state where the examinee W is seated in a chair or the like; it suffices for the radiographic image capturing device 10 to be a device that captures an image of the breasts N of that examinee W in a state where at least the upper half of the body of the examinee W is upright.

The radiographic image capturing device 10 is, as shown in FIG. 1, equipped with a measuring unit 12 that is disposed on the front of the device and is substantially C-shaped when seen from the side and a base unit 14 that supports the measuring unit 12 from the back of the device.

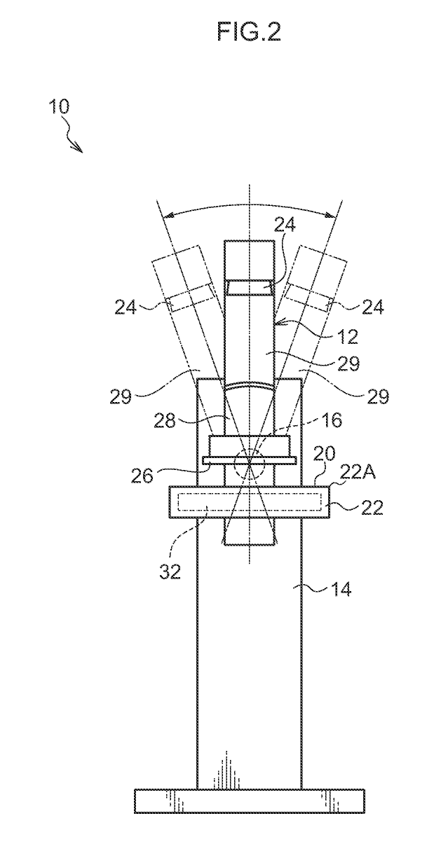

The measuring unit 12 is, as shown in FIG. 1 and FIG. 2, equipped with an object table 22 on which is formed a planar imaging surface 20 on which the breasts N of the standing examinee W rest, a compression plate 26 that presses the breasts N against the imaging surface 20, and a holding unit 28 that holds the object table 22 and the compression plate 26.

Further, the measuring unit 12 is equipped with a radiation source 24 that is disposed with a X-ray tube and irradiates the imaging surface 20 with radiation for examination from the X-ray tube and a support unit 29 that is separate from the holding unit 28 and supports the radiation source 24.

In the measuring unit 12, there is disposed a rotating shaft 16 that is rotatably supported in the base unit 14. The rotating shaft 16 is fixed with respect to the support unit 29, so that the rotating shaft 16 and the support unit 29 are configured to rotate integrally.

The rotating shaft 16 is configured so as to be switchable between a state where the rotating shaft 16 is coupled to and rotates integrally with the holding unit 28 and a state where the rotating shaft 16 is decoupled from the holding unit 28 and idles. Specifically, gears are respectively disposed in the rotating shaft 16 and the holding unit 28, and the rotating shaft 16 can switch between a state where these gears are meshed together and a state where these gears are unmeshed.

Switching between transmission and non-transmission of the rotating force of the rotating shaft 16 is not limited to being accomplished with the above-described gears and can be accomplished using various machine elements.

The holding unit 28 holds the object table 22 and the radiation source 24 such that the imaging surface 20 and the radiation source 24 are a predetermined distance apart from each other and slidably holds the compression plate 26 such that the distance between the compression plate 26 and the imaging surface 20 is variable.

The imaging surface 20 with which the breasts N come into contact is formed by carbon, for example, from the standpoint of radiolucency and strength. Inside the object table 22, there is disposed a radiation detector 32 that is irradiated with the radiation that has passed through the breasts N and the imaging surface 20 and detects that radiation. The radiation that the radiation detector 32 has detected is visualized and a radiographic image is generated.

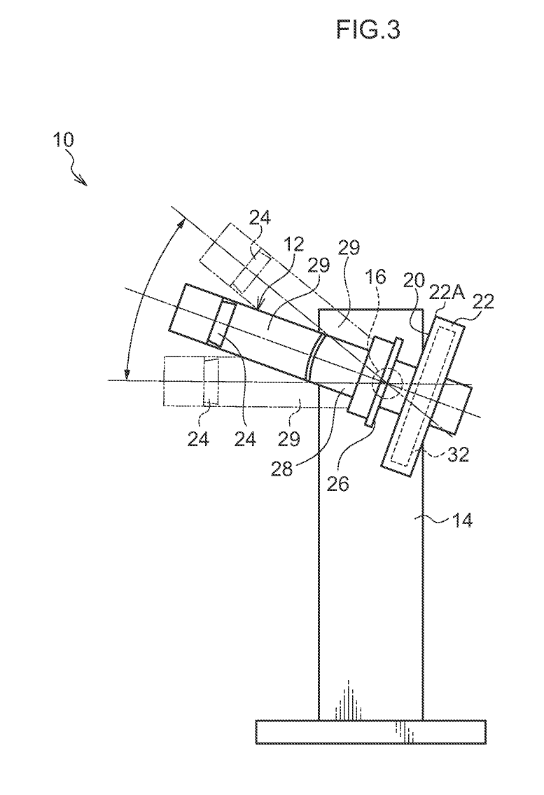

The radiographic image capturing device 10 pertaining to the exemplary embodiment is a device that can at least obtain both a craniocaudal view (CC imaging) and a mediolateral oblique view (MLO view) of the breasts N. FIG. 1 and FIG. 2 show the orientation of the radiographic image capturing device 10 during CC imaging, and FIG. 3 shows the orientation of the radiographic image capturing device 10 during MLO imaging.

As shown in FIG. 1, during CC imaging, the orientation of the holding unit 28 is adjusted to a state where the imaging surface 20 faces upward and the orientation of the support unit 29 is adjusted to position the radiation source 24 over (above) the imaging surface 20. Thus, the breasts N are irradiated with radiation from the radiation source 24 from the head to the feet of the standing examinee W, and CC imaging is performed.

Further, on the surface on the front side of the object table 22, there is formed a chest wall surface 30 with which the portion of the chest of the examinee W lower than the breasts N is brought into contact. The chest wall surface 30 is planar.

During MLO imaging, as shown in FIG. 3, the orientation of the holding unit 28 is adjusted to a state where the object table 22 is rotated from 45° to 90° in comparison to during CC imaging and the armpit of the examinee W is positioned such that it is brought into contact with a side wall corner portion 22A on the front side of the object table 22. Thus, the breasts N are irradiated with radiation from the radiation source 24 from the axial center of the torso of the standing examinee W outward, and MLO imaging is performed.

In the radiographic image capturing device 10, as shown in FIG. 2, when switched to a stereo imaging mode, the rotating shaft 16 idles with respect to the holding unit 28, the object table 22 and the compression plate 26 do not move, and the support unit 29 rotates, whereby only the radiation source 24 moves in a circular arc.

In this manner, by causing only the radiation source 24 to rotate, it becomes possible to position the radiation source 24 in plural positions having disparity.

Thus, by allowing one of the plural images that have been captured in plural positions having disparity to be viewed by the right eye and allowing the other to be viewed by the left eye, a stereo view of images becomes possible.

Here, in the radiographic image capturing device 10, when capturing a second radiographic image after a first radiographic image that has been captured in the past, the radiation source 24 is capable of irradiating the subject with radiation in the same position as the imaging position of the first radiographic image.

Specifically, when capturing the second radiographic image, the angle-of-rotation of the holding unit 28 and the support unit 29 with respect to the base unit 14 is made to be the same as when the first radiographic image was captured, whereby the imaging position in the second radiographic image is made to be the same position as the imaging position in the first radiographic image.

For example, position information of the imaging position in the first radiographic image is stored in a storage unit disposed inside or outside the radiographic image capturing device 10, so that the radiographic image capturing device 10 can reference the position information and determine the imaging position in the second radiographic image when capturing the second radiographic image.

Further, position information of the imaging position in the first radiographic image may be inputted by an input unit to which the position information is capable of being inputted from outside the radiographic image capturing device 10, so that the radiographic image capturing device 10 may reference the position information and determine the imaging position in the second radiographic image when capturing the second radiographic image.

Moreover, it is possible to configure the radiographic image capturing device 10 as described below in order to irradiate the subject with radiation in the same position as the imaging position of the first radiographic image when capturing the second radiographic image.

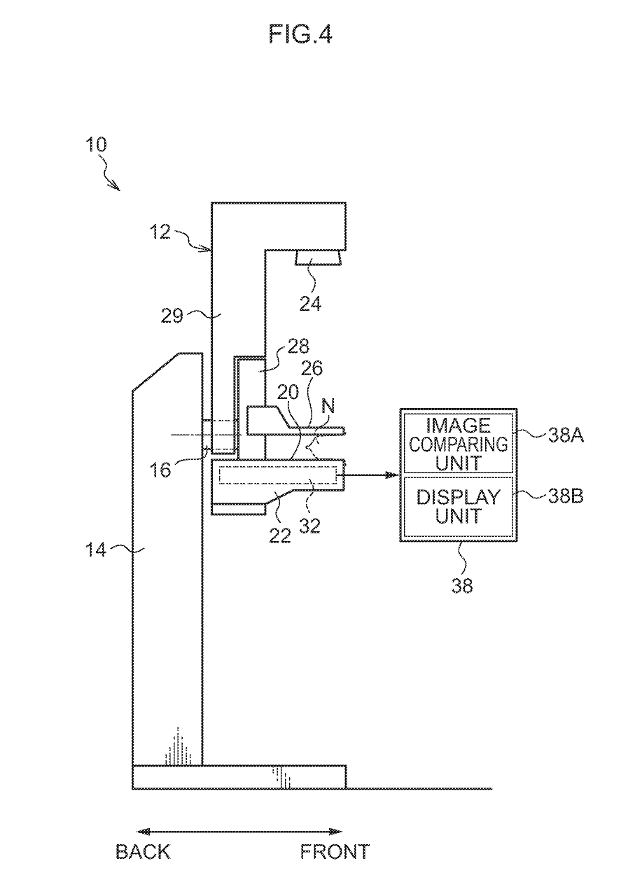

The radiographic image capturing device 10 may be, as shown in FIG. 4, equipped with a display device 38 that displays the degree of alignment between the positions of a third radiographic image in which the breasts N resting on the object table 22 have been captured and the first radiographic image.

The display device 38 is equipped with an image comparing unit 38A that compares the first radiographic image and the third radiographic image to detect the amount of positional misalignment between the first radiographic image and the third radiographic image. The image comparing unit 38A identifies a corresponding portion (e.g., an outline of the breasts, the mammary glands) in the first radiographic image and the third radiographic image and detects the amount of misalignment therebetween. The display device 38 displays the amount of misalignment on a display unit (display screen) 38B. The display device 38 may also be a device that uses an average of misalignment amounts detected at plural points as the amount of misalignment that the display device 38 displays. The display device 38 may alternatively, rather than the amount of misalignment itself, display an amount of correction corresponding to that amount of misalignment.

Thus, an operator can, on the basis of the position of the breasts N or the examinee W in the third radiographic image, grasp how the position should be changed so that it matches the imaging position of the first radiographic image when capturing the second radiographic image.

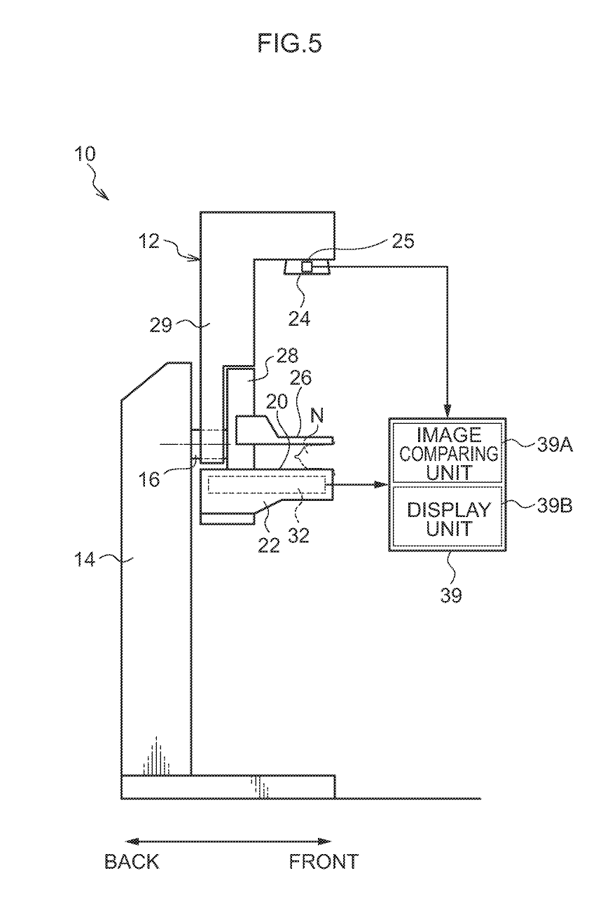

The image to be compared with the first radiographic image is not limited to a radiographic image, and the radiographic image capturing device 10 may also be configured such that it is separately disposed with an optical image capturing device that captures an image of the breasts N. In this configuration, as shown in FIG. 5, an optical image capturing device 25 including a CCD camera and the like is built into the radiation source 24 directing the same direction as the radiation source 24.

In this configuration, the radiographic image capturing device 10 is equipped with a display device 39 that displays the degree of alignment between an optical image in which the breasts N resting on the object table 22 have been captured by the optical image capturing device 25 and the first radiographic image. The display device 39 is equipped with an image comparing unit 39A that compares the first radiographic image and the optical image and detects the amount of positional misalignment between the first radiographic image and the optical image. The image comparing unit 39A identifies a corresponding portion (e.g., an outline of the breasts, the mammary glands) in the first radiographic image and the optical image and detects the amount of misalignment therebetween. The display device 39 displays that amount of misalignment on a display unit (display screen) 39B.

Thus, an operator can, on the basis of the position of the breasts N or the examinee W in the optical image, grasp how the position should be changed so that it matches the imaging position of the first radiographic image when capturing the second radiographic image.

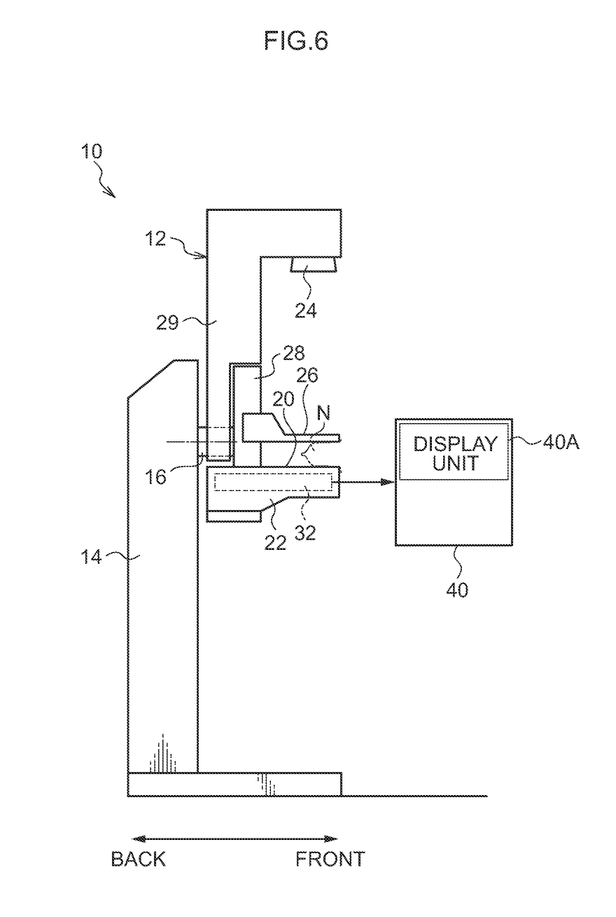

Instead of the configuration in which the radiographic image capturing device 10 displays the degree of alignment between the optical image or the third radiographic image and the first radiographic image, for example, as shown in FIG. 6, the radiographic image capturing device 10 may also have a configuration equipped with a display device 40 that displays the first radiographic image. In this configuration, the display device 40 displays the first radiographic image on a display unit (display screen) 40A. An operator can align the position of the breasts N or the examinee W such that it matches the first radiographic image while looking at the first radiographic image displayed on the display unit 40A.

It is desirable for the display device 40 to be in a position where an operator can easily see it when positioning the examinee W; for example, it is desirable for the display device 40 to be disposed somewhere around the object table 22.

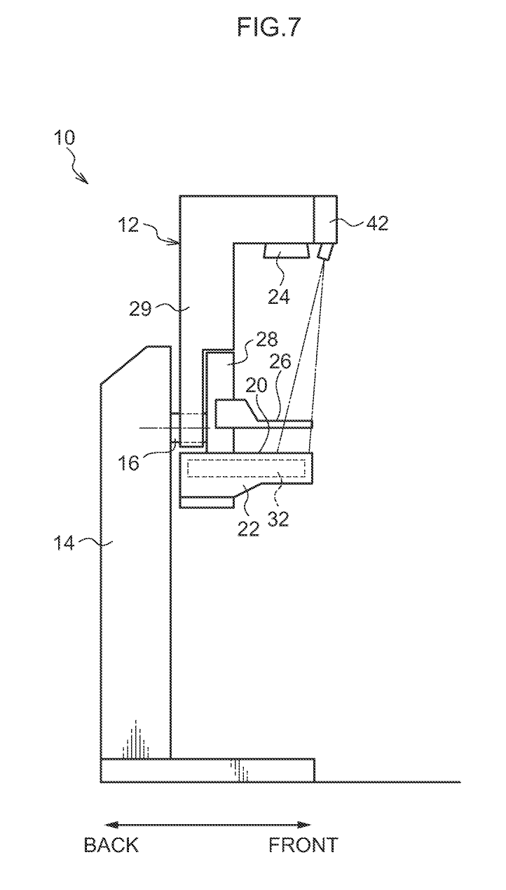

The display device that displays the first radiographic image may also, as shown in FIG. 7, be a projector 42 serving as a projection device that projects the first radiographic image onto the imaging surface 20. In this configuration, an operator can align the position of the breasts N or the examinee W such that it coincides with the first radiographic image displayed on the imaging surface 20.

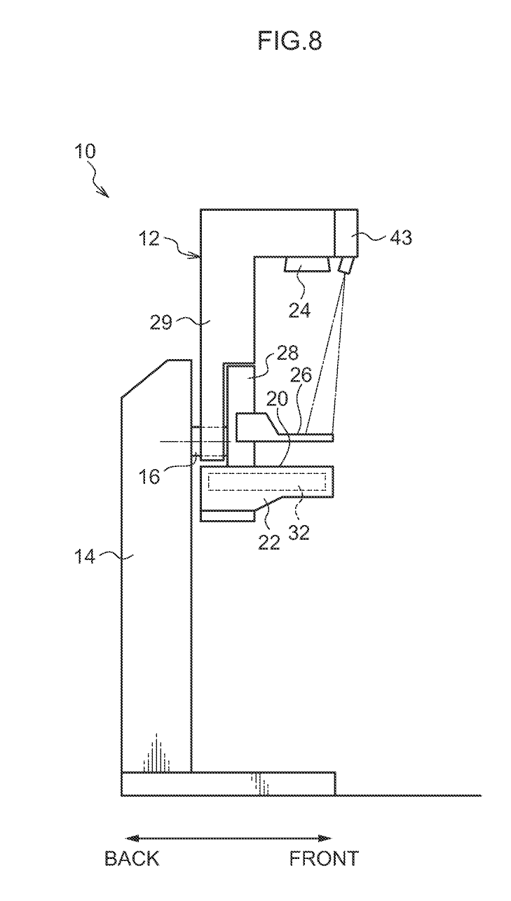

The display device that displays the first radiographic image may also, as shown in FIG. 8, be a projector 43 serving as a projection device that projects the first radiographic image onto the compression plate 26. In this configuration, an operator can align the position of the breasts N or the examinee W such that it coincides with the first radiographic image displayed on the compression plate 26.

In the above-described configuration, the orientation of the radiation source 24 is changed with respect to the object table 22 and the compression plate 26 by driving force from the rotating shaft 16 during stereo imaging. However, the configuration is not limited to this and the radiation source 24 may also be moved by driving force from another mechanism. For example, rails serving as one example of guide members that guide the radiation source 24 in a circular arc may be disposed, and the radiation source 24 may be moved by those rails.

(Configuration of Image Displaying System 48)

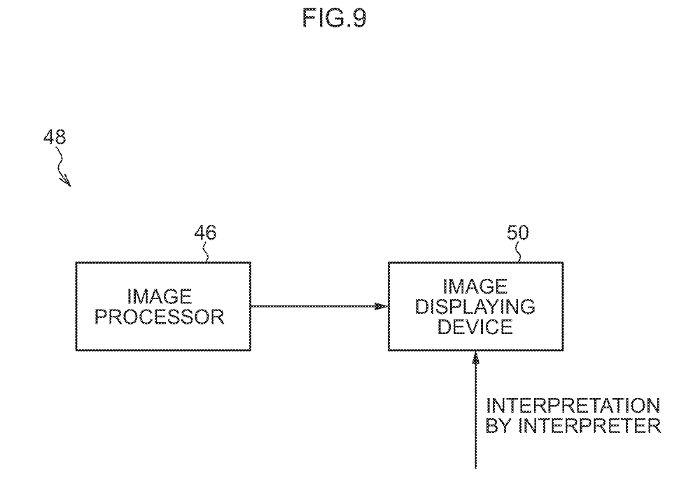

The image displaying system 48 is, as shown in FIG. 9, equipped with an image processor 46 that aligns a first radiographic image that has been captured in the past and a second radiographic image that has been captured after the first radiographic image such that the first radiographic image and the second radiographic image become similar, and an image displaying device 50 that serves as a display unit that displays the first radiographic image and the second radiographic image that have been aligned by the image processor 46, allows one radiographic image to be viewed by the right eye and allows the other radiographic image to be viewed by the left eye.

The reason the image processor 46 performs alignment of the images is that, when the first radiographic image and the second radiographic image differ due to changes in the size/shape of the breasts N resulting from body habitus changes or changes in the imaging conditions (e.g., the degree of compression of the breasts, the positioning of the breasts), it can correct that difference.

The alignment of the first radiographic image and the second radiographic image is performed by transforming at least one of the first radiographic image and the second radiographic image.

As techniques of performing this alignment, there are: a technique of performing comprehensive alignment (linear transformation such as affine transformation) including rotation, parallel translation and enlargement/reduction with respect to the entirety of at least one image of the two images in regard to the same subject serving as the target of comparison, performing local alignment resulting using nonlinear distortion transformation (e.g., nonlinear distortion transformation using curve fitting resulting from a 2-dimensional polynomial) processing (warping) based on a corresponding positional relationship that has been obtained by template matching per local region, or a combination of comprehensive alignment and local alignment, further performing realignment of a local region whose degree of positional misalignment is high and its neighboring region, and the like.

It is desirable for the image processor 46 to perform the alignment by aligning the first radiographic image with respect to the second radiographic image. The reason the image processor 46 transforms the first radiographic image rather than the second radiographic image is because it is desirable to compare images on the basis of the most recent image. Alternately, the image processor 46 may also be configured to align the second radiographic image with respect to the first radiographic image.

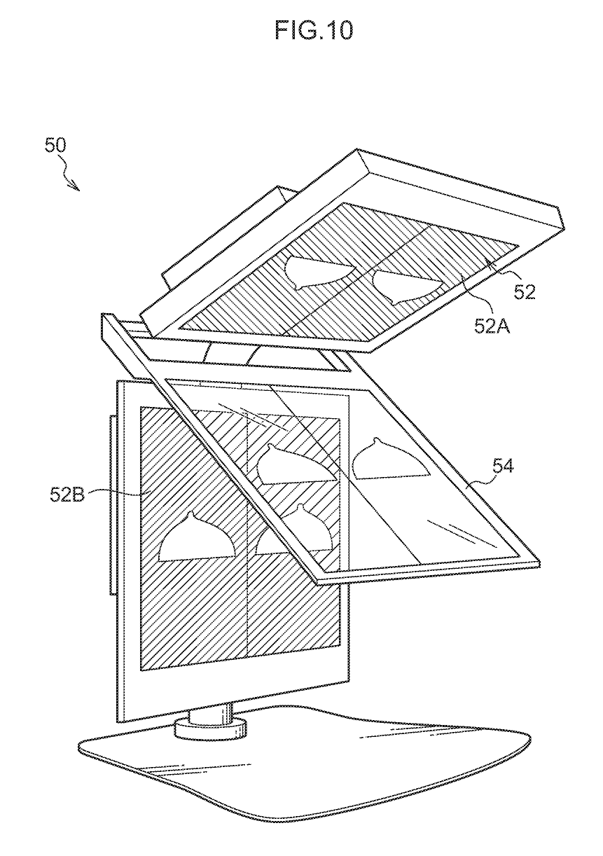

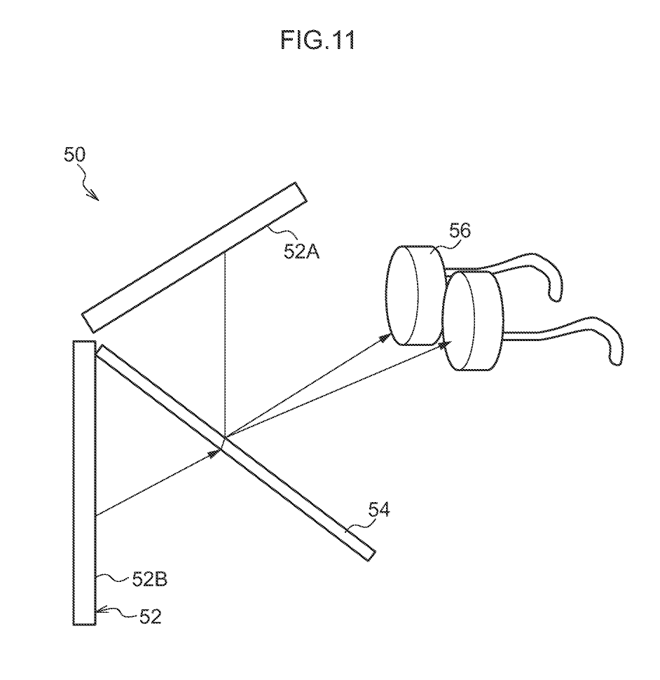

The image displaying device 50 pertaining to the exemplary embodiment has, as shown in FIG. 10 and FIG. 11, a display screen 52 for displaying images and a beam splitter mirror (polarizing plate) 54. The display screen 52 includes an upper screen 52A disposed on the upper side and a lower screen 52B disposed on the lower side.

The first radiographic image and the second radiographic image that have been aligned by the image processor 46 are sent to the image displaying device 50 and are displayed by the image displaying device 50.

For example, the first radiographic image may be displayed on the upper screen 52A. The image displayed on the upper screen 52A is reflected by the beam splitter mirror (polarizing plate) 54 and is viewed by the right eye of a radiologist/technologist wearing deflection glasses 56.

The second radiographic image may be displayed on the lower screen 52B. The image displayed on the lower screen 52B passes through the beam splitter mirror (polarizing plate) 54 and is viewed by the left eye of the radiologist/technologist wearing the deflection glasses 56.

At this time, if the first radiographic image and the second radiographic image are similar images, there will be no disparity, and the images will be perceived by the radiologist/technologist as a planar image.

On the other hand, if there is an abnormal portion in either the first radiographic image or the second radiographic image, there will be disparity in that portion, and that portion will be perceived by the radiologist/technologist as a convex portion or a concave portion.

Thus, when comparing and interpreting the first radiographic image and the second radiographic image captured thereafter, any abnormal portion can be discovered without having to perform image processing for combining images. For that reason, reading/interpreting efficiency when comparing and interpreting a radiographic image and a radiographic image that has been captured thereafter can be improved without having to perform cumbersome processing.

The present invention is not limited to mammography and the above-described exemplary embodiment and is capable of being variously modified, altered and improved.

For example, while the present embodiment employs two display screens, embodiments are not limited thereto. The image for right eye (first radiographic image) and the image for left eye (second radiographic image) may be displayed on a single display screen in a state in which the two images are alternately displayed in 60 frame/sec which is double in speed of usual bit rate (30 frame/sec).

Further, the alignment method of the two images is not limited to that in the present embodiment. After the first and second radiographic images are aligned by image processing by the image processor 46, the images may be further moved or deformed according to a use's (radiologist's and/or technologist's) instruction input by input devices such as a mouse or the like.

According to the disclosed configuration, reading/interpreting efficiency when comparing and interpreting a radiographic image and a radiographic image that has been captured thereafter can be improved without having to perform cumbersome processing.

What is claimed is:

1. An image displaying system comprising:
an image processor that moves and/or deforms a first radiographic image and a second radiographic image that has been captured after the first radiographic image such that the first radiographic image and the second radiographic image are aligned and
a display unit that displays the first radiographic image and the second radiographic image that have been aligned, allows one of the first and second radiographic image to be viewed by the right eye, and allows the other of the first and second radiographic image to be viewed by the left eye.

2. An image capturing and displaying system comprising:
the image displaying system according to claim 1; and
a radiographic image capturing device that comprises:
a movable radiation source that irradiates a subject with radiation in the same position as an imaging position of the first radiographic image when capturing the second radiographic image; and
a radiation detector that detects the radiation with which the subject has been irradiated from the movable radiation source and which has passed through the subject, with a radiographic image being generated from that detected radiation.

3. An image capturing and displaying system comprising:
the image displaying system according to claim 1; and
a radiographic image capturing device that comprises:
a movable radiation source that irradiates a subject with radiation; and
a radiation detector that detects the radiation with which the subject has been irradiated from the movable radiation source and which has passed through the subject, with a radiographic image being generated from that detected radiation.

4. The image capturing and displaying system according to claim 3, wherein the radiographic image capturing device further comprises:
an object table on which the subject rests; and
a display device that displays the degree of alignment between a third radiographic image in which the subject resting on the object table has been captured and the first radiographic image.

5. The image capturing and displaying system according to claim 3, wherein the radiographic image capturing device further comprises:
an object table on which the subject rests;
an optical image capturing device that captures, from the same direction as the radiation source, the subject resting on the object table; and
a display device that displays a degree of alignment between an optical image that is obtained by the optical imaging device and the first radiographic image.

6. The image capturing and displaying system according to claim 3, wherein the radiographic image capturing device further comprises a display device that displays the first radiographic image.

7. The image capturing and displaying system according to claim 6, wherein the display device comprises a projection device that projects the first radiographic image onto an object table on which the subject rests.

8. The image capturing and displaying system according to claim 6, wherein the display device comprises a projection device that projects the first radiographic image onto a compression plate that compresses the subject.

9. The image capturing and displaying system according to claim 2, further comprising a storage unit that stores position information of the imaging position in the first radiographic image,
wherein the radiographic image capturing device references the position information to determine the imaging position in the second radiographic image when capturing the second radiographic image.

10. The image capturing and displaying system according to claim 2, further comprising an input unit to which is inputted position information of the imaging position in the first radiographic image,
wherein the radiographic image capturing device references the position information to determine the imaging position in the second radiographic image when capturing the second radiographic image.

11. The image displaying system according to claim 1, wherein the image processor performs alignment of the first radiographic image and the second radiographic image by transforming at least one of the first radiographic image and the second radiographic image.

12. The image displaying system according to claim 11, wherein the transformation includes any of
comprehensive alignment including at least one of rotation, parallel translation and enlargement/reduction with respect to the entirety of the at least one image,
local alignment resulting from nonlinear distortion transformation based on a corresponding positional relationship that has been obtained by template matching per local region, and
a combination of these.
